(19) United States
(12) Patent Application Publication
(10) Pub. No.: US 2025/0214495 A1
(43) Pub. Date: Jul. 3, 2025

(54) SEAT

(71) Applicant: TOYOTA BOSHOKU KABUSHIKI KAISHA, Aichi-ken (JP)

(72) Inventors: Kazuki OSHIMA, Aichi-ken (JP); Masahiko IYODA, Aichi-ken (JP); Takeshi USHIYAMA, Aichi-ken (JP); Yuji NAKANO, Aichi-ken (JP)

(73) Assignee: TOYOTA BOSHOKU KABUSHIKI KAISHA, Aichi-ken (JP)

(21) Appl. No.: 18/982,188

(22) Filed: Dec. 16, 2024

(30) Foreign Application Priority Data
Dec. 27, 2023 (JP) 2023-221325

(51) Int. Cl. B60N 2/64; B60N 2/68

(52) U.S. Cl. CPC B60N 2/643; B60N 2/68

(57) ABSTRACT

A seat includes a cushion body and a seat frame. The cushion body is configured to elastically support a seater. The seat frame is configured to support the cushion body from the backside of the seat. The cushion body has a main portion and each side portion that is a side portion of the main portion in a seat width direction. The main portion has a main pad and a main substrate. The main substrate has a pair of side bulged portions that bulges into a pair of recessed parts in the seat width direction. The pair of side bulged portions has two side portions formed in the seat width direction on the backside of the main pad.

### CROSS-REFERENCE TO RELATED APPLICATION

This application claims priority to Japanese patent application serial number 2023-221325, filed Dec. 27, 2023, the content of which is incorporated herein by reference in its entirety for all purposes.

### TECHNICAL FIELD

The present disclosure relates to a seat. In particular, the present disclosure relates to a seat having a cushion body that elastically supports a seater and a seat frame that supports the cushion body from the backside of the seat.

### BACKGROUND

For example, a prior art discloses a seat in which a cushion body comprises a seat pad and a seat cover that wraps the seat pad. The cushion body is divided into three parts in the seat width direction. Specifically, the cushion body is divided into a main portion that forms the central portion in the seat width direction and each side portion that forms a side portion in the seat width direction. The main portion and each side portion are separately fixed to the seat frame.

In the configuration of the above prior art, the main portion and each side portion are not connected to each other, so the main portion tends to sink. Therefore, a wobble of the seater in a yaw direction cannot be properly suppressed. Thus, there is a need for a seat that can appropriately reduce the wobble of the seater, even when the main portion is separated from the side portion.

### SUMMARY OF THE DISCLOSURES

According to one aspect of the present disclosure, a seat comprises a cushion body, which elastically supports a seater, and a seat frame, which supports the cushion body from the backside of the seat. The cushion body comprises: a main portion and two side portions. The main portion is a central portion in the seat width direction. The main portion has a seat pad and a main substrate attached in the back. The main substrate has a pair of side bulged portions that is expandable in order to enter into a pair of recessed parts in the two side portions on the backside of the main pad.

### BRIEF DESCRIPTION OF DRAWINGS

FIG. 1 is a perspective view of the schematic configuration of a seat.

FIG. 2 is an exploded perspective view of a seat back of FIG. 1.

FIG. 3 is an exploded perspective view of the seat back with a fabric member removed from a back frame.

FIG. 4 is a perspective view of the seat back wherein the fabric member is assembled to the back frame.

FIG. 5 is a rear-view of the seat back wherein the fabric member is assembled to the back frame.

FIG. 6 is a front-view of the seat back wherein the fabric member is assembled to the back frame.

FIG. 7 is a perspective view of a cushion body from backside.

FIG. 8 is a rear-view of the cushion body.

FIG. 9 is a front-view of the seat back wherein each side portion is assembled to the back frame.

FIG. 10 is a front-view of the seat back wherein a main portion is assembled to the back frame.

FIG. 11 is a perspective view of the seat back wherein the main portion in FIG. 10 is only a main substrate.

FIG. 12 is a cross-sectional view taken along a line XII-XII in FIG. 10.

FIG. 13 is a cross-sectional view taken along a line XIII-XIII in FIG. 10.

FIG. 14 is a cross-sectional view taken along a line XIV-XIV in FIG. 10.

FIG. 15 is a cross-sectional view taken along a line XV-XV in FIG. 10.

### DETAILED DESCRIPTION

An embodiment of the present disclosure will be described with reference to the figures.

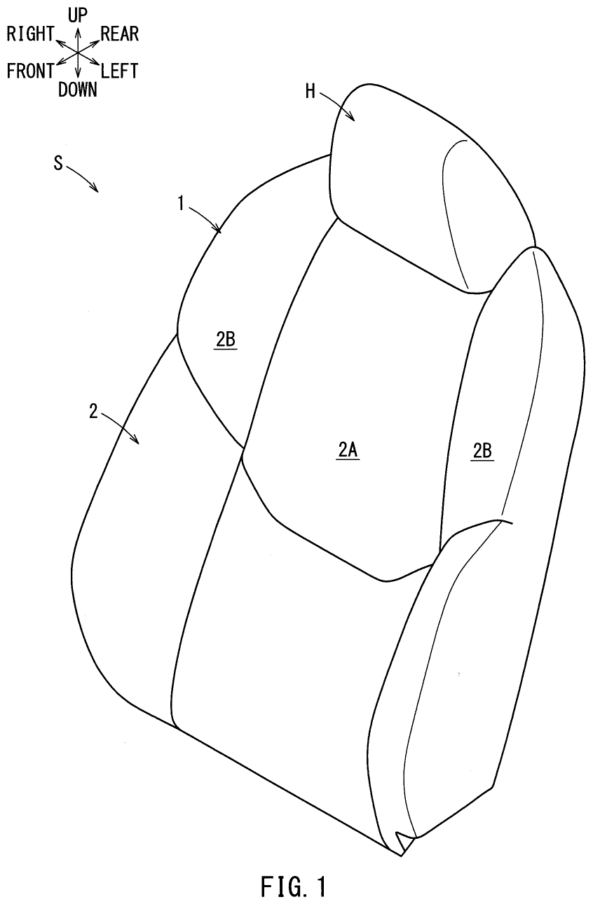

First, the configuration of a seat S according to an embodiment of the present disclosure will be explained with reference to FIGS. 1 to 15. In the following description, when each direction such as front/rear, up/down, and right/left is indicated, it shall refer to the respective direction indicated in each figure.

When “seat” is appended to each direction, such as “seat width direction,” it shall refer to the respective direction with respect the seat S. In the following explanation, when a specific reference figure is not shown or when there is no corresponding sign in the reference figure, one of the figures from FIGS. 1 to 15 shall be referred to as appropriate.

As shown in FIG. 1, the seat S is a one-seater seat of an automobile. The seat S comprises a seat back 1, which serves as a backrest for a seater, a seat cushion (not shown), which serves as a seating portion, and a headrest H, which serves as a headrest.

The seat back 1 is connected to the right and left rear ends of the seat cushion via a recliner (not shown) at the lower ends of the right and left sides of the seat back 1. Therefore, it can adjust the angle of back recline the seat cushion, respectively.

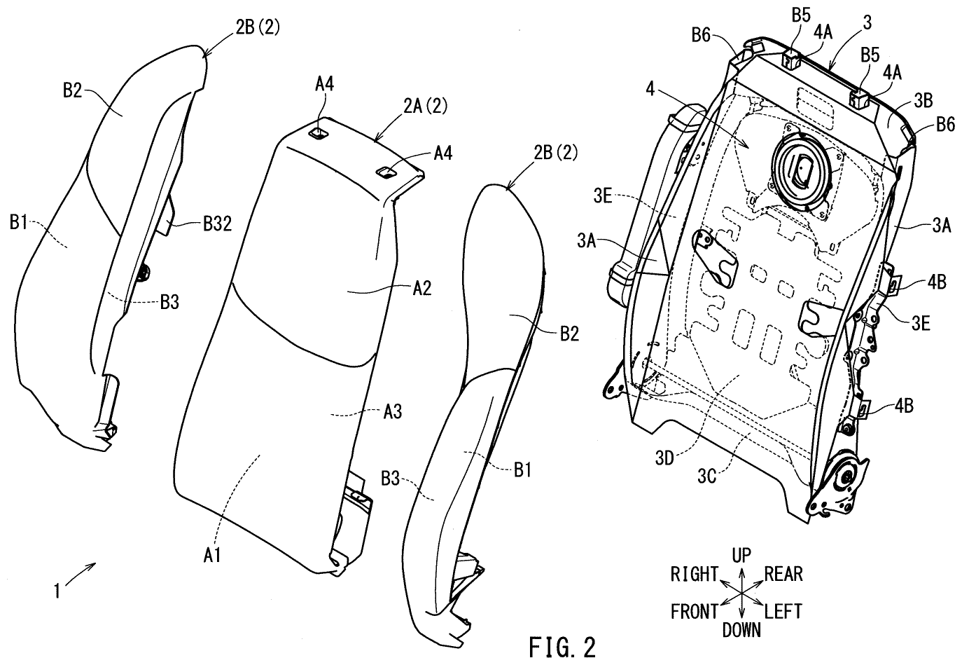

As shown in FIG. 2, the seat back 1 has a cushion body 2 that elastically supports the back of the seater and a back frame 3 that supports the cushion body 2 from the backside (rear side) of the seat. The cushion body 2 is divided into three separate elements, a main portion 2A, which is the center portion in the seat width direction, and two side portions 2B in the seat width direction. Here, the back frame 3 corresponds to a “seat frame” of the present disclosure.

The back frame 3 is a metal member assembled in a frame shape in front view. A lumbar support 3D is provided inside the frame of the back frame 3. The lumber support 3D enhances the support of the seater's lower back. The seat back 1 has a fabric member 4, which is made of non-woven fabric, stretched within the frame of the back frame 3. The fabric member 4 is, for example, made of a needle-punched nonwoven fabric.

The fabric member 4 supports the main portion 2A against the back frame 3 from the backside of the seat. The fabric member 4 functions like a hammock, stretching within the frame of the back frame 3 to position in front of the lumbar support 3D.

The cushion body 2 is divided into the main portion 2A and each side portion 2B as described above, so that each divided element can be replaced respectively. The main portion 2A and side portions 2B can be easily assembled to the back frame 3 by access from the front of the seat.

The main portion 2A is separated from each of the side portions 2B, which makes it easier for the main portion 2A to sink into the backside of the seat against the load received from the back of the seater. The reason for this is that the pads of the main portion 2A and each side portion 2B are not connected to each other.

If the main portion 2A tends to sink into the backside of the seat, the body of the seater is not sufficiently supported by the main portion 2A during the vehicle cornering. As a result, the body of the seater tends to wobble in the yaw direction.

Therefore, the seat S of the embodiment has a structure that can properly support the main portion 2A from the backside of the seat in order to properly suppress the wobble of the seater's body in the yaw direction. One such structure is to support the main portion 2A from the backside of the seat by means of the fabric member 4 described above.

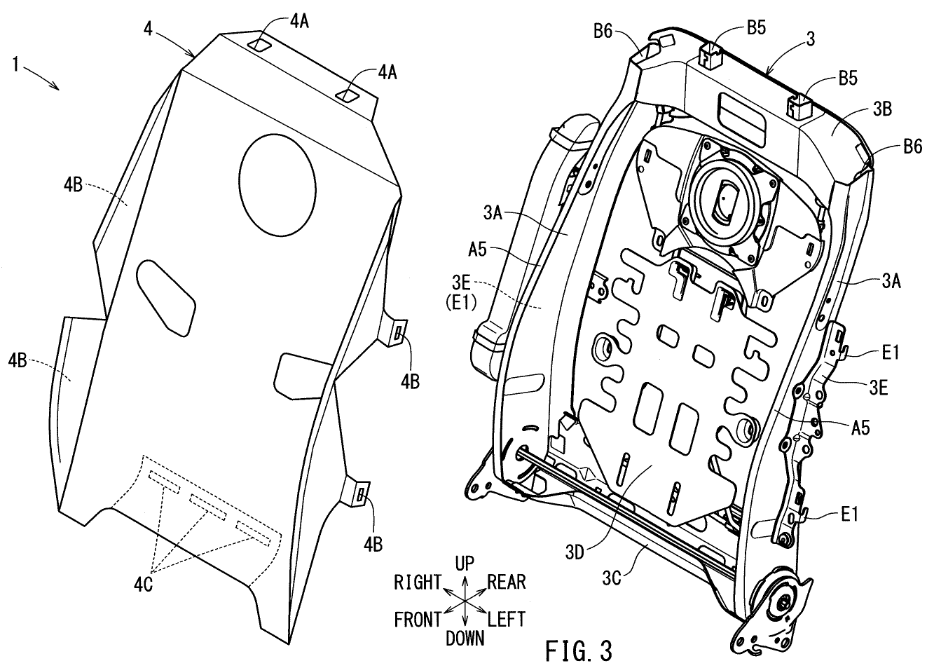

The specific configuration of each part of the seat back 1 will be described in detail below. First, the configuration of the back frame 3 will be explained. As shown in FIG. 3, the back frame 3 has a pair of side frames 3A extending in the seat height direction along both right and left sides of the seat back 1.

The back frame 3 has an upper frame 3B extending in the seat width direction along the upper part of the seat back 1. The back frame 3 also has a lower frame 3C extending in the seat width direction along the lower part of the seat back 1.

The back frame 3 further has the lumbar support 3D that is suspended from the upper frame 3B between the side frames 3A. The lower part of the lumbar support 3D is elastically supported by the lower frame 3C from the backside of the seat via a spring (not shown).

A bracket 3E is bolted to the outer portion of each side frame 3A. The bracket 3E is provided with a hook μl. The hook μl can hook upper and lower side hook holes 4B formed at each end of the right and left sides of the fabric member 4. Each hook μl is in the form of a claw projecting from each bracket 3E toward the rear-side of the seat.

The upper frame 3B has a headrest support bracket B5 welded to the upper frame 3B at two positions on its right and left sides, penetrating in the seat height direction. The headrest support brackets B5 are square cylindrical in shape extending in the seat height direction. These headrest support brackets B5 are holders for inserting and attaching from above the seat a pair of right and left headrest stays (not shown) that hang down from the headrest H described above in FIG. 1.

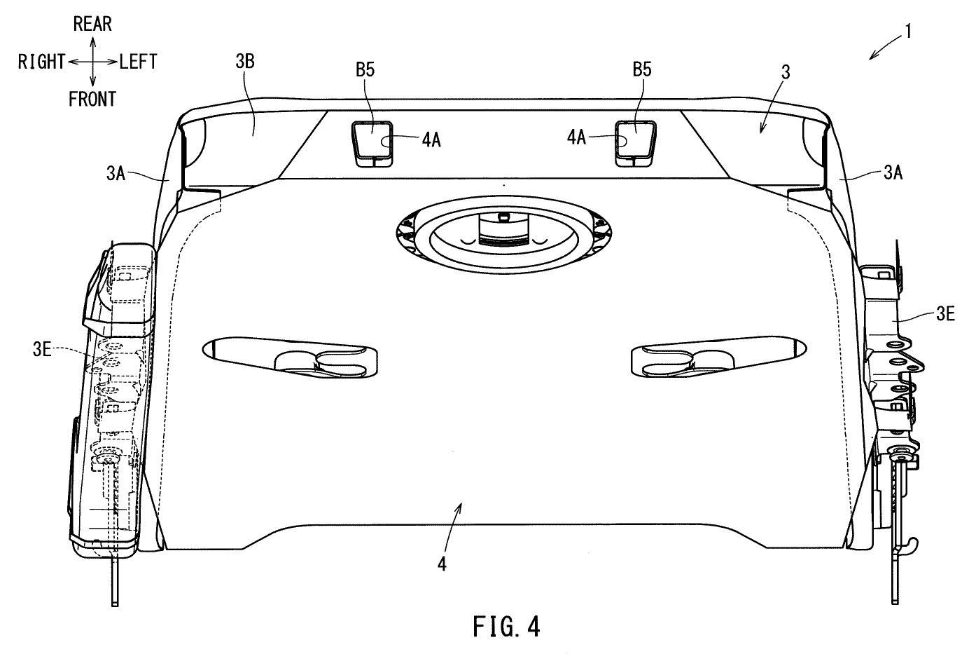

The fabric member 4 is assembled to the back frame 3 as follows. First, as shown in FIG. 4, two upper hook holes 4A formed in the upper end of the fabric member 4 are hooked by passing them through the tips of each headrest support bracket B5, which projects upward from the upper frame 3B, from above the seat.

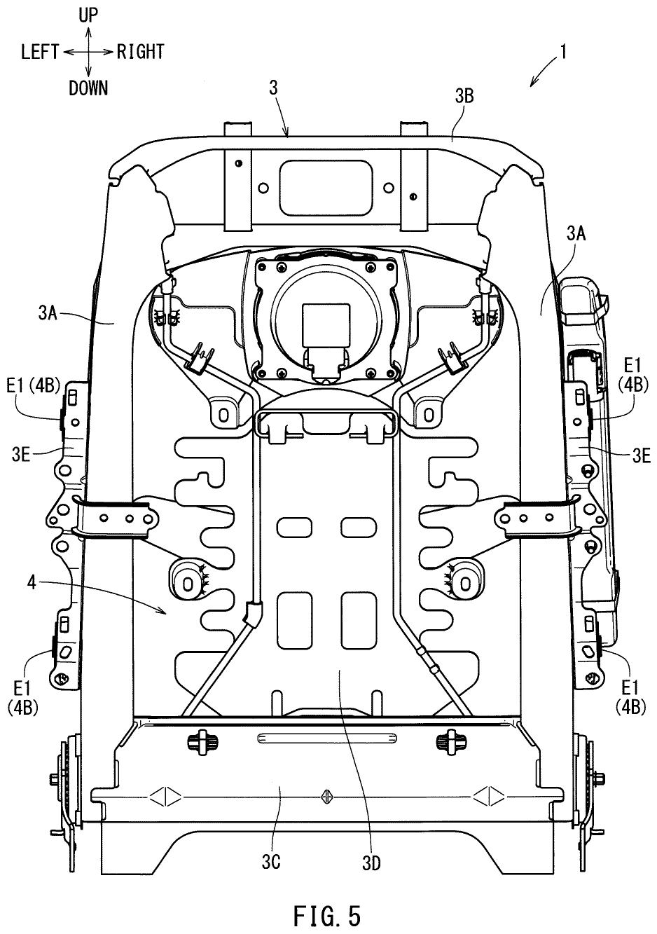

Next, the fabric member 4 is suspended from the front of the back frame 3 using the hooked portion of the fabric member 4 as a fulcrum. Then, as shown in FIG. 5, each of the right and left end of the fabric member 4 is pulled in so as to wrap around each side frame 3A from the outside to the rear side.

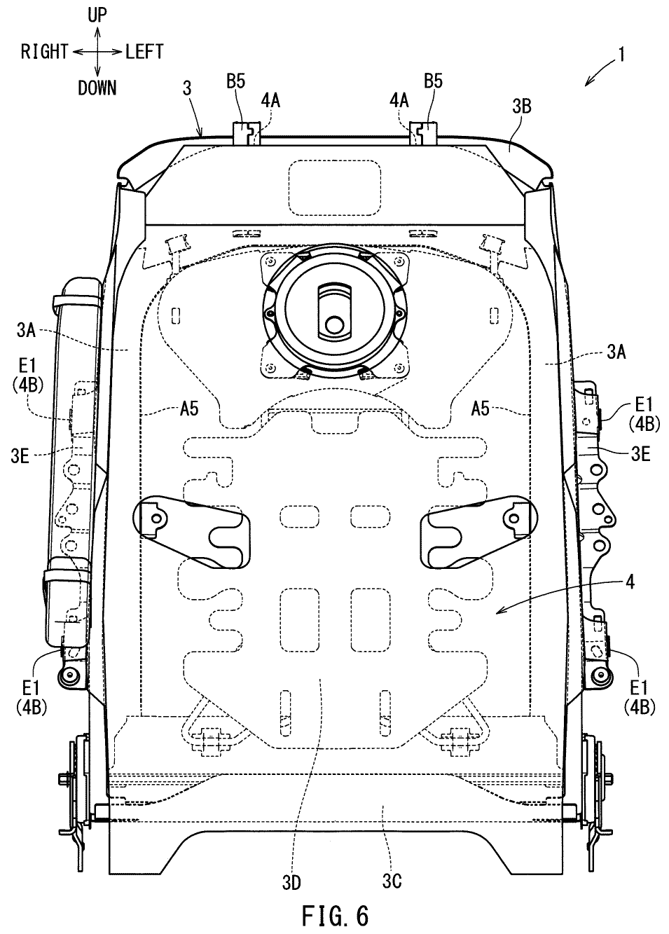

Then, the two side hook holes 4B formed at the right and left ends of the fabric member 4 are hooked by passing them through the corresponding hooks μl from the rear side of the seat. As shown in FIG. 6, the fabric member 4 is stretched across the upper frame 3B and each side frame 3A to cover the seat from the front side.

The lower end of the fabric member 4 is hooked to the lower frame 3C of the back frame 3. Specifically, the lower end of the fabric member 4 is hooked to the lower frame 3C as the main portion 2A is assembled to the back frame 3. This assembly of the lower end of the fabric member 4 will be described in detail in conjunction with the description of the main portion 2A below.

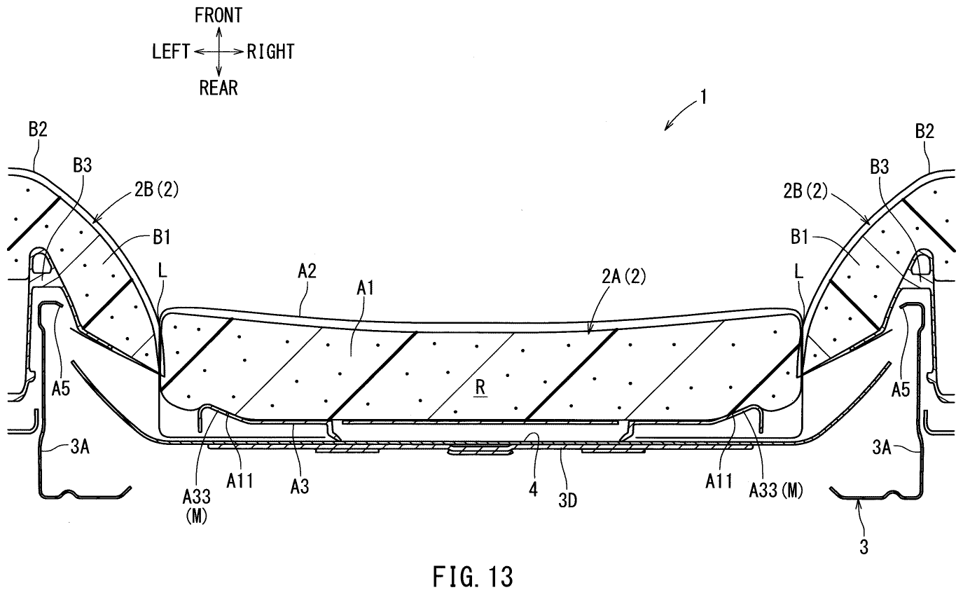

As described above, the fabric member 4 covers the front edge A5 from the front of the seat. The front edge A5 is a portion where the front edge of each side frame 3A is folded inward in the seat width direction. In addition, the fabric member 4 extends across a division line L between the main portion 2A and each side portion 2B in the seat width direction (see FIGS. 13 to 15). The division line L will be described later.

Next, the configuration of the main portion 2A and each side portion 2B will be described. As shown in FIGS. 2, 7, and 8, the main portion 2A has a main pad A1, which is made of urethane foam, a main cover A2, which is made of fabric covering the main pad A1, and a main substrate A3, which is made of resin and attached to the main pad A1 from backside of the pad.

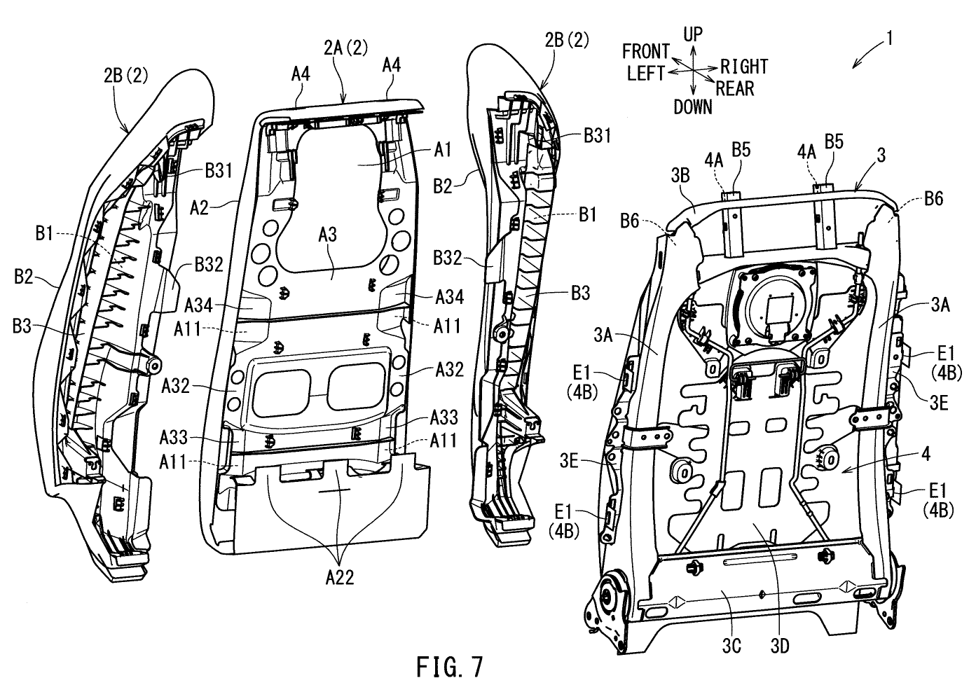

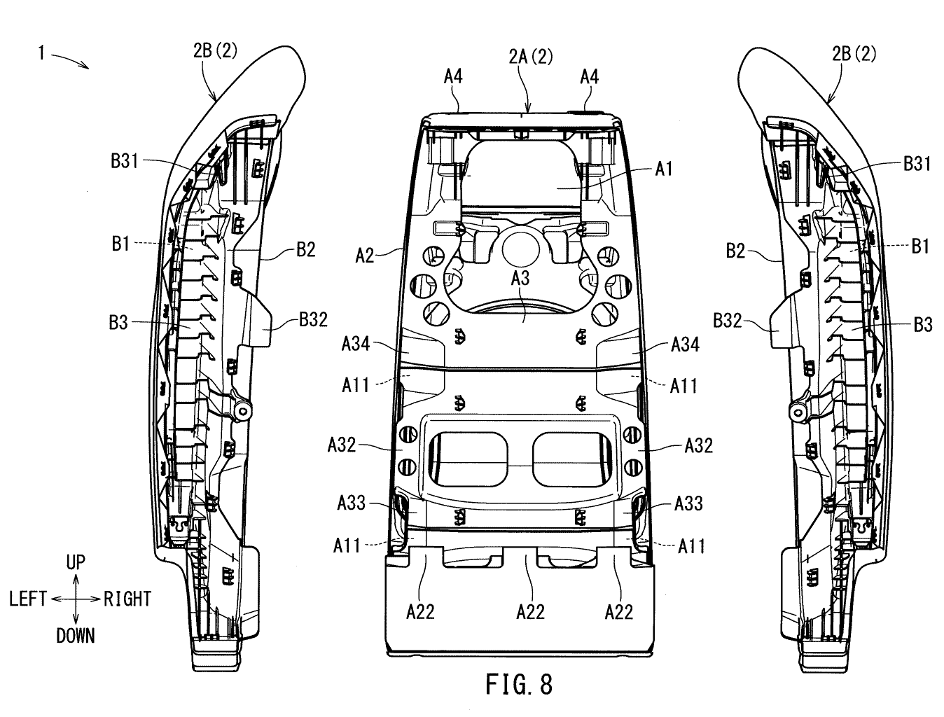

The main cover A2 covers the main pad A1 from the front of the pad. As shown in FIGS. 7 and 8, the main cover A2 has upper, right, and left ends pulled into the backside of the main pad A1. Each end of the main cover A2 attaches to each edge of the main substrate A3, which is attachable to the backside of the main pad A1.

The main pad A1 are wrapped and integrated with the main substrate A3 by the main cover A2. Thus, the main substrate A3 is fixed to the backside of the main pad A1 by the main cover A2.

As shown in FIGS. 2, 7, and 8, each side portion 2B also has a side pad B1, which is made of urethane foam, a side cover B2, which is made of fabric covering the side pad B1, and a side substrate B3, which is made of resin attached to the side pad B1 from the backside of the pad.

Each side cover B2 covers the side pad B1 from the front of the pad. As shown in FIGS. 7 and 8, each side cover B2 has its upper, lower, right, and left ends pulled into the backside of the side pad B1. Each end of the side cover B2 is then fixed to each edge of the side substrate B3, which is attached to the backside of the side pad B1.

The side pad B1 are wrapped and integrated with the side substrate B3 by each side cover B2. Thus, each side substrate B3 is fixed to the backside of the side pad B1 by the side cover B2.

As shown in FIG. 2, the main portion 2A and each side portion 2B are individually assembled to the back frame 3 by access from the front of the seat. The main portion 2A and each side portion 2B are assembled to the back frame 3 from the front of the seat after the fabric members 4 are assembled to the back frame 3.

In specific, each side portion 2B is first assembled to the back frame 3. The assembly procedure is as follows. As shown in FIG. 7, a fitting projection B31 positions on the upper edge of the side substrate B3 of each side portion 2B. The fitting projection B31 hangs down from the eaves portion of the backside of the substrate. Fitting holes B6, which open upwardly, are on right and left upper ends of the upper frame 3B. First, the fitting projections B31 are hooked by passing them through the fitting holes B6 from above.

Next, set each side portion 2B against each side frame 3A from the front using the hooked portion of each side portion 2B as a fulcrum. Then, each side portion 2B is pressed against each side frame 3A from the front side.

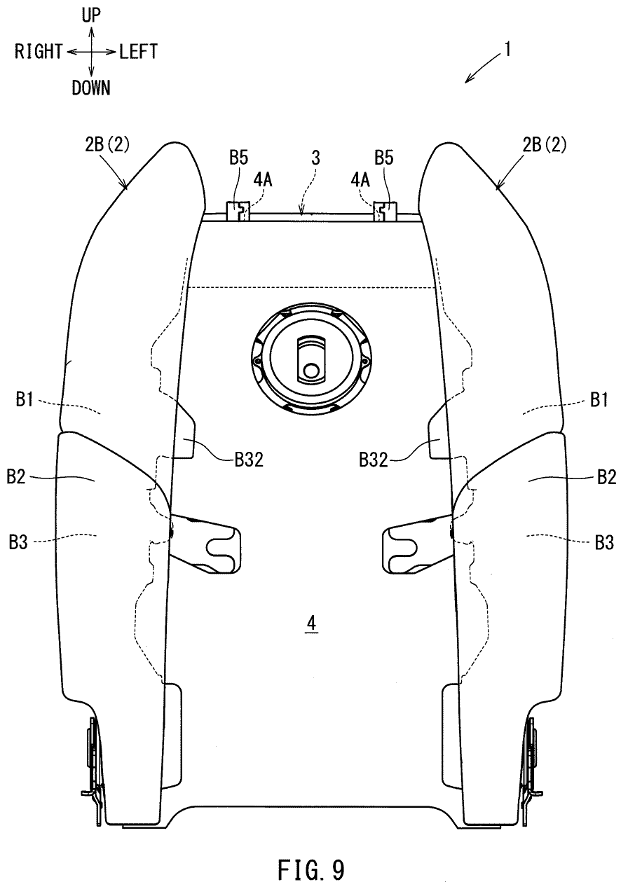

Thereby, the clips (not shown), which are assembled to each side substrate B3, are inserted from the front of the seat into the attaching holes of the corresponding brackets 3E bolted to each side frame 3A for a snap-fitting. As shown in FIG. 9, each side portion 2B is integrally fixed to the back frame 3.

After the above assembly, the main portion 2A (see FIG. 2) is subsequently assembled to the back frame 3. The assembly procedure is as follows. As shown in FIG. 7, two upper hook holes A4 are formed in the eaves portion of the main portion 2A. The eaves portion is a portion which project rearward from the upper edge of the main portion 2A. Two right and left headrest support brackets B5 are formed from the upper frame 3B projecting upwardly. First, the two right and left upper hook holes A4 are hooked by passing the two right and left upper hook holes A4 through the two right and left headrest support brackets B5 from above the seat.

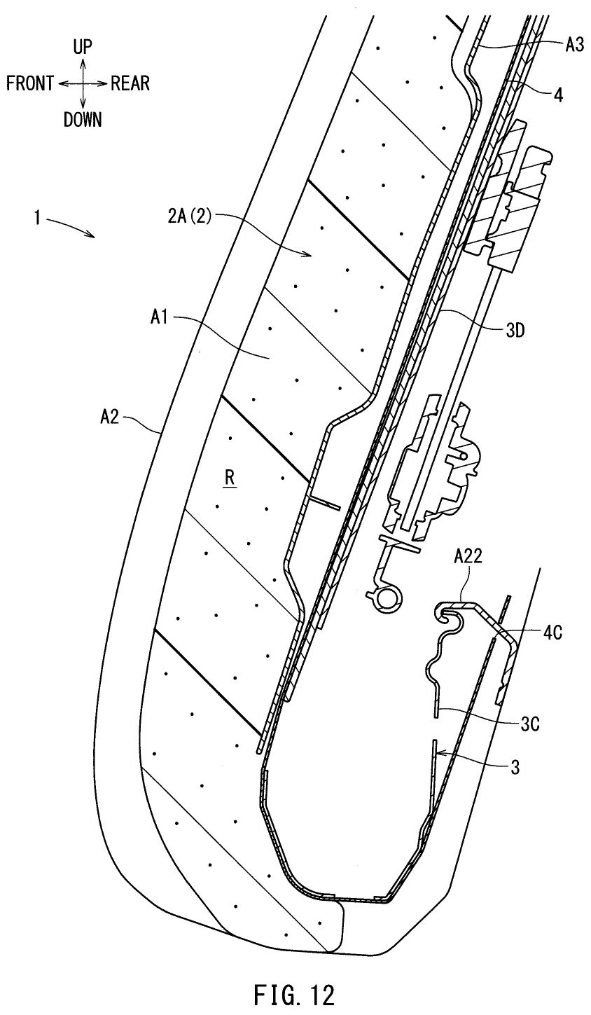

As shown in FIG. 12, set the main portion 2A against the lumbar support 3D (more specifically, against the fabric member 4 located on the front side of the lumbar support 3D) from the front using the above hooked portion as a fulcrum. Next, the lower end of the main cover A2 is pulled rearwardly together with the lower part of the main pad A1 so as to wrap around the lower frame 3C from the lower side.

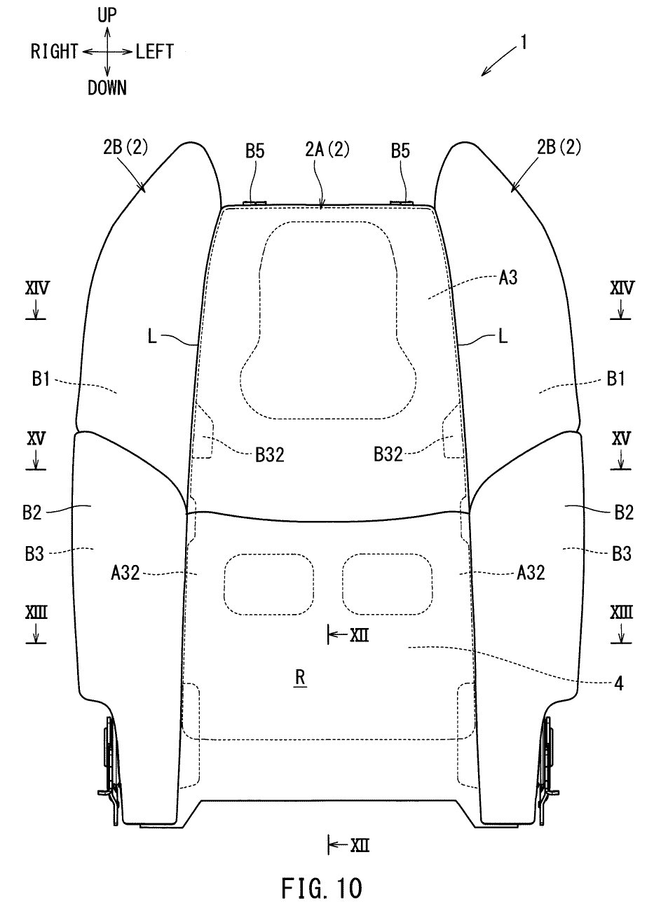

A claw A22, which is made of a plastic J-hook, is sewn to the lower end of the main cover A2. The main cover A2 is fixed by hooking the claw A22 to the lower frame 3C from the lower side. As shown in FIG. 10, the main portion 2A is integrally fixed to the back frame 3 with the gap between the main portion 2A and each of the side portion 2B in the seat width direction (the division lines L) being filled.

As shown in FIG. 12, a lower hook hole 4C is formed at the lower end of the fabric member 4. The lower end of the main cover A2 described above is such that when the claw A22 is hooked to the lower frame 3C, the claw A22 is first passed through the lower hook hole 4C. Thereby, as the lower end of the main cover A2 is fixed to the lower frame 3C, the lower end of the fabric member 4 is also fixed to the lower frame 3C via the main cover A2.

The fabric member 4 is also wrapped around the lower frame 3C from the lower side together with the main portion A2 and the main pad A1. With the above assembly, the upper part of the main portion 2A is supported from the backside of the seat by the upper frame 3B (see FIG. 7). In addition, the middle to lower part of the main portion 2A is elastically supported from the backside of the seat by the lumbar support 3D.

Furthermore, the main portion 2A is supported in flat manner from the backside of the seat by the fabric member 4 stretched on the back frame 3 (see FIGS. 12 to 15). Therefore, the main portion 2A can be supported from the backside of the seat to the extent that the seater feels adequate firmness.

Even if a load in the yaw direction is input from the back of the seater during vehicle cornering, both side portions of the main portion 2A are supported from the backside of the seat by the fabric member 4. This configuration prevents the main portion 2A from sinking into the backside. It further enables the main portion 2A to support the body of the seater during vehicle cornering in a manner that prevents the body of the seater from wobbling in the yaw direction, even though the main portion 2A is separated from each of the side portion 2B.

As shown in FIGS. 13 to 15, the fabric member 4 is provided to extend across the division line L between the main portion 2A and each side portion 2B in the seat width direction. Therefore, the fabric member 4 can prevent foreign matter from entering the seat through the gap between the main portion 2A and each side portion 2B.

Each side portion 2B is supported from the backside of the seat by each side frame 3A over substantially the entire area in the seat height direction. Each side portion 2B is configured so that the side substrate B3 supports the side pad B1 from the obliquely outer side of the backside of the seat. Thereby, each side portion 2B is able to properly support the back of the seater from both the right and left sides.

In detail, the side substrate B3 of each side portion 2B supports the side pad B1 from the obliquely outer side of the backside of the seat in a planar manner by the surface portion. The surface portion is a diagonally extending portion that covers each side frame 3A from the front side and from the inside in the seat width direction. These structures make each side substrate 2B more difficult to sink into the backside of the seat than the main portion 2A.

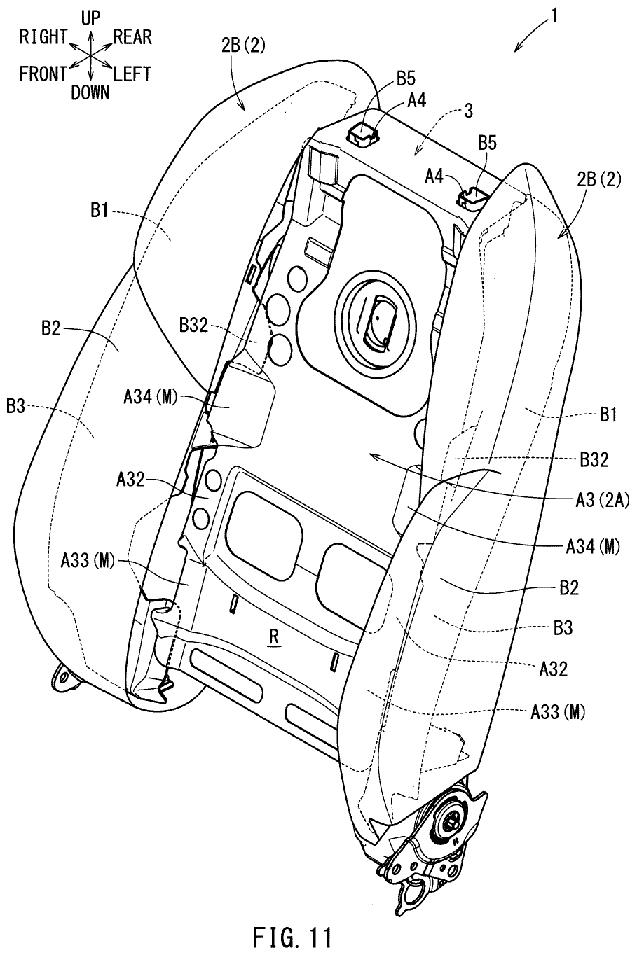

As shown in FIG. 11, the main substrate A3 of the main portion 2A has a frame shape in the front view. Specifically, the main substrate A3 has a ladder shape with the right and left frame side portions A32 of the main substrate A3 connected at several points in the seat height direction.

The right and left frame side portions A32 of the main substrate A3 are formed with first side bulged portions A33 that bulge out toward the frontside of the seat in the area near their lower portions. The first side bulged portions A33 are formed in a position where they overlap with the pelvic support portion R of the main portion 2A, i.e., the portion supporting the pelvis of the seater, in the seat height direction. Here, each first side bulged portion A33 corresponds to a “side bulged portion” of the present disclosure.

As shown in FIG. 13, each first side bulged portion A33 is extruded from the right and left frame side portions A32 of the main substrate A3 forming an inclined surface M. The inclined surface M is a portion facing diagonally inward from the left and right frame side portions A32 of the main substrate A3 toward the front of the seat. The main pad A1 has a recessed part A11 formed in the right and left side portions of the back surface of the pad. The recessed part A11 is concave portion in accordance with the shape of the first side bulged portion A33 projecting from the main substrate A3.

Thereby, each first side bulged portion A33 is shaped to bulge into the respective recessed part A11 of the main pad A1. Since the first side bulged portion A33 is bulging, the side portions of the main pad A1 are thinner than the center portion. Further, the back of the seater is strongly supported by the first side bulged portions A33 from the backside of the seat.

In detail, the main pad A1 is supported by the inclined surface M of each first side bulged portion A33 from the obliquely outer side of the backside of the seat. Thereby, the main portion 2A supports the pelvis of the seater in a planar manner from both the right and left sides by the inclined surface M of each first side bulged portion A33 of the main substrate A3.

Therefore, even when the load in the yaw direction is applied from the pelvis of the seater during the vehicle cornering, both side portions of the main portion 2A are strongly supported from the backside of the seat by the respective first side bulged portions A33. The main portion 2A is not likely to sink into the backside of the seat. This configuration enables the main portion 2A to support a seater's body in such a way that it does not easily wobble in the yaw direction during the vehicle cornering even though the main portion 2A is separated from each side portion 2B.

Each first side bulged portion A33 is formed in the main substrate A3 fixed to the back frame 3. Therefore, the wobble of the seater in the yaw direction can be more appropriately reduced by each first side bulged portion A33 of the main substrate A3 supported by the back frame 3.

As shown in FIG. 11, the right and left frame side portions A32 of the main substrate A3 are supported from the backside of the seat by extending portions B32 that extend inward from each side substrate B3 in the seat width direction. These extending portions B32 are formed at a position above the pelvic support portion R of the main portion 2A.

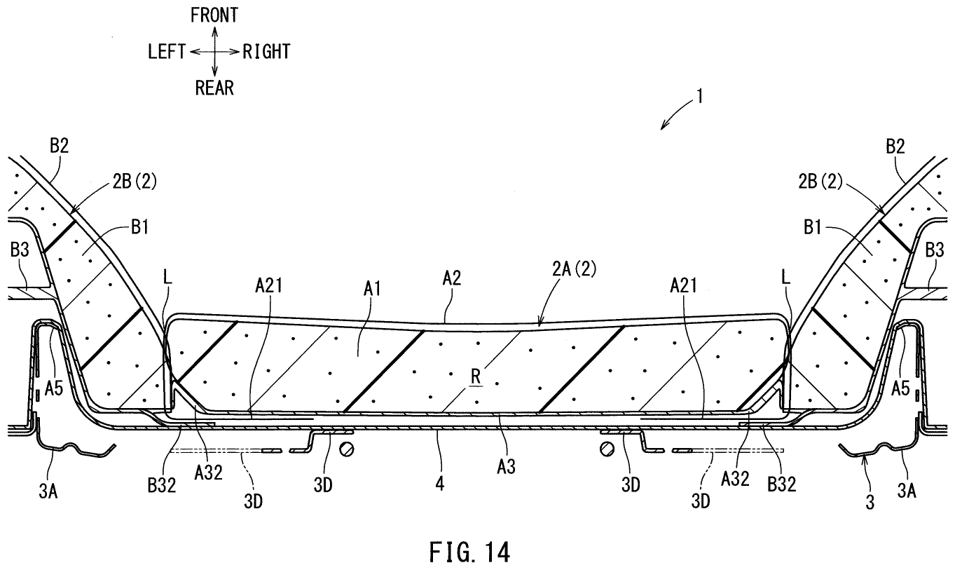

As shown in FIG. 14, the extending portion B32 extends flatly beyond the division line L between the main portion 2A and each side portion 2B from outside to inside in the seat width direction. In detail, the extending portion B32 extends inward to a position where it overlaps the lumbar support 3D in seat width alignment.

The extending portion B32 is positioned between the main portion 2A and the lumbar support 3D. Since the main portion 2A is supported by the extending portions B32 from the backside of the seat, the right and left side portions of the main portion 2A can strongly support the back of the seater from the backside of the seat.

The both side portions of the main portion 2A are strongly supported from the backside of the seat by the respective extending portions B32, and the main portion 2A is less likely to sink into the backside of the seat even when the load in the yaw direction is applied from the pelvis of the seater during the vehicle cornering. Therefore, even though the main portion 2A is separated from each side portion 2B, it is possible to support the body of the seater so that the body of the seater is less likely to wobble in the yaw direction during the vehicle cornering.

The right and left frame side portions A32 of the main substrate A3, which is supported by each extending portion B32 from the backside of the seat, are covered from the backside of the seat by a substrate covering portion A21. The substrate covering portion A21 is a portion of the cover end drawn into the backside of the seat of the main cover A2. By having the substrate covering portion A21 interposed between the main substrate A3 and each extending portion B32 in this manner, direct contact between the main substrate A3 and each extending portion B32 can be reasonably prevented. As a result, the generation of abnormal noise caused by resin hitting each other can be appropriately suppressed. In FIGS. 7 and 8, the substrate covering portion A21 is omitted in order to clearly show the configuration of the main substrate A3.

Each extending portion B32 extends from each side substrate B3 inwardly in the seat width direction. Therefore, even if the main portion 2A is assembled to the back frame 3 after each side substrate 2B is assembled to the back frame 3, each extending portion B32 does not interfere with the assembly of the main portion 2A.

As shown in FIG. 11, in the right and left frame side portions A32 of the main substrate A3, a second side bulged portion A34 that expands forward of the seat is formed in the middle area in the seat height direction between the first side bulged portion A33 and the extending portion B32. Here, the second side bulged portions A34 corresponds to a “side bulged portion” of the present disclosure.

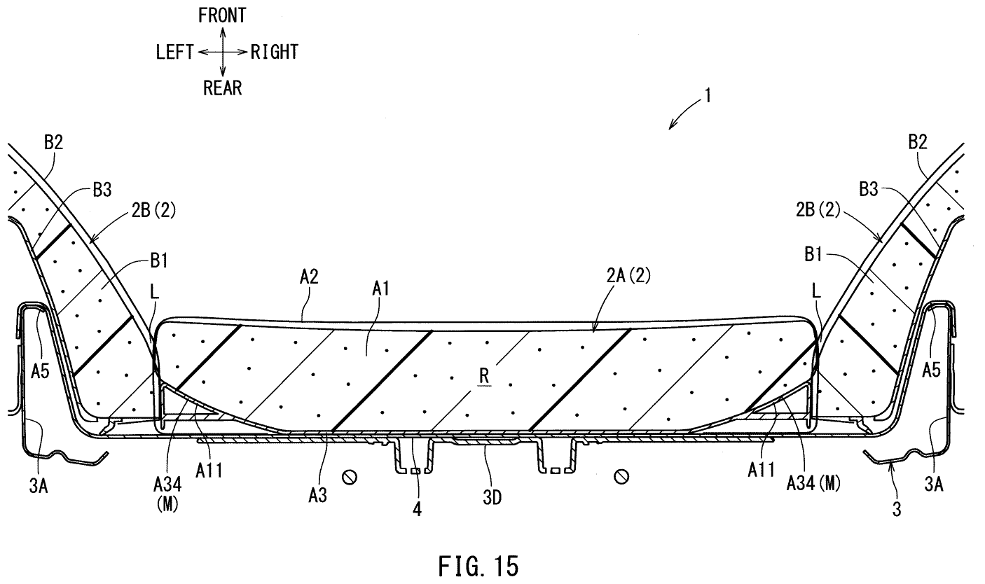

As shown in FIG. 15, each second side bulged portion A34 is extruded from the right and left frame side portions A32 of the main substrate A3 to form the inclined surface M facing diagonally inward toward the front of the seat. The main pad A1 has the recessed part A11 formed in the right and left side portions of the backside of the pad. The recessed part A11 is a concave portion in accordance with the shape of the second side bulged portion A34 projecting from the main substrate A3.

Thereby, each second side bulged portion A34 is shaped to bulge into the respective recessed part A11 of the main pad A1. Due to the expansion of the second side bulged portion A34, the main portion 2A has both side portions of the main pad A1 thinner than the center portion, so that the back of the seater can be strongly supported from the backside of the seat.

The inclined surface M of each second side bulged portion A34 supports the main pad A1 from the obliquely outer side of the backside of the seat. Thereby, the main portion 2A supports the back of the seater in a planar manner from both the right and left sides by the inclined surface M of each second side bulged portion A34 of the main base substrate A3.

The main portion 2A is strongly supported from the backside of the seat by each second side bulged portion A34 even when the load in the yaw direction is applied from the back of the seater during the vehicle cornering. Therefore, the main portion 2A is less likely to sink into the backside of the seat. Accordingly, even though the main portion 2A is separated from each side portion 2B, the main portion 2A can still support the body of the seater to prevent the body from wobbling in the yaw direction during the vehicle cornering.

Each second side bulged portion A34 is formed in the main substrate A3 fixed to the back frame 3. Therefore, the wobble of the seater in the yaw direction can be more appropriately reduced by each second side bulged portion A34 of the main substrate A3, which is supported by the back frame 3.

In summary, the seat S of the embodiment has the following configuration. In the following, the numbers in parentheses are the reference numbers corresponding to the respective configurations shown in the above embodiments.

A seat(S) has a cushion body (2) that elastically supports a seater and a seat frame (3) that supports the cushion body (2) from the backside of the seat. The cushion body (2) comprises three separate elements: a main portion (2A), which is the center portion in the seat width direction, and two portions (2B), left and right in the seat width direction. The main portion (2A) has a main pad (A1), which is a seat pad, and a main substrate (A3), which is applied to the backside of the main pad (A1).

The main substrate (A3) has a pair of side bulged portions (A33, A34) in the seat width direction. The side bulged portions (A33, A34) bulge into a pair of recessed parts (A11) in the seat width direction and form in both side portions in the seat width direction on the backside of the main pad (A1). According to the above configuration, the pair of side bulged portions (A33, A34) of the main substrate (A3) can support both side portions of the main pad (A1) from the backside of the seat more strongly than the center portion. Thus, a wobble of the seater in a yaw direction can be reduced even if the main portion (2A) is separated from each side portion (2B).

The pair of side bulged portions (A33) are provided at a position where a pelvis support portion (R) of the main portion (2A), which supports the pelvis of the seater in the seat back (1), overlaps the arrangement in the seat height direction. According to the above configuration, the pair of side bulged portions (A33) of the main substrate (A3) can suppress rotation of the pelvis of the seater in the yaw direction. As a result, the wobble of the seater in the yaw direction can be more appropriately reduced.

In addition, the main substrate (A3) is fixed to the seat frame (3). According to the above configuration, the pair of side bulged portions (A33, A34) of the main portion (A3) supported by the seat frame (3) can further appropriately reduce the wobble of the seat seater in the yaw direction.

The pair of side bulged portions (A33, A34) have an inclined surface (M) that is inclined to support the main pad (A1) in the corresponding pair of recessed parts (A11) from the obliquely outer side of the backside of the seat. According to the above configuration, the pair of side bulged portions (A33, A34) of the main substrate (A3) can properly support the seater from the lateral direction as well. As a result, the wobble of the seater in the yaw direction can be more appropriately reduced.

According to one aspect of the present disclosure, a seat having a cushion body that elastically supports a seater and a seat frame that supports the cushion body from the backside of the seat. The cushion body comprises three separate elements: a main portion, which is the central portion in the seat width direction, and two side portions, left and right, in the seat width direction. The main portion has a main pad, which is a seat pad, and a main substrate, which is applied to the backside of the main pad. The main substrate has a pair of side bulged portions in the seat width direction that bulge into a pair of recessed parts in the seat width direction formed in the two side portions in the seat width direction on the backside of the main pad.

Therefore, the pair of side bulged portions of the main substrate can strongly support the two side portions of the main pad from the backside of the seat than the center portion. Thus, a wobble of the seater in a yaw direction can be reduced even when the main portion is separated from each of the two side portions.

According to another aspect of the present disclosure, the pair of side bulged portions are provided at a position where the pair of side bulged portions overlaps the arrangement in the seat height direction with a pelvis support portion of the main portion, which supports the pelvis of the seater in the seat back. Alternatively, the pair of side bulged portions are provided at position where the pair of side bulged portions overlaps the arrangement in the seat front-rear direction with the ischium support portion of the main portion. The ischium support portion is the portion of the seat cushion that supports the right and left ischium of the seater.

Therefore, the rotation of the pelvis or right and left ischium of the seater in the yaw direction can be suppressed by the pair of side bulged portions of the main substrate. As a result, the wobble of the seater in the yaw direction can be more appropriately reduced.

According to another aspect of the present disclosure, the main substrate is fixed to the seat frame.

Therefore, the wobble of the seater in the yaw direction can be more appropriately reduced by the pair of side bulged portions of the main substrate supported by the seat frame.

According to another aspect of the present disclosure, the pair of the side bulged portions have an inclined surface that is inclined to support the main pad in the corresponding pair of recessed parts from the obliquely outer side of the backside of the seat.

Therefore, the pair of side bulged portions of the main substrate can properly support the seater from the lateral direction as well. As a result, the wobble of the seater in the yaw direction can be more appropriately reduced.

Although an embodiment of the present disclosure has been described, the present disclosure can be implemented in various forms in addition to the above embodiment.

1. The seat of the present disclosure may be applied to vehicles other than automobiles, such as trains, aircraft, and ships. In addition to vehicles, the seat may be applied to various facilities such as sports facilities, theaters, concert halls, event halls, etc. (for non-vehicle use). The configuration of the present disclosure can be applied to a seat cushion as well as a seat back.

2. The bulging shape of the pair of side bulged portions provided on the main substrate may be an extruded shape that forms an inclined surface that faces diagonally inward toward the front of the seat, or it may be an extruded shape that forms a cylindrical shape toward the front of the seat.

When the configuration of the present disclosure is applied to a seat cushion, it is preferred that the pair of side expanded portions provided in the main substrate be provided in a position where the arrangement in the seat front-rear direction overlaps with the ischium supporting portions of the main portion supporting the right and left ischium of the seater in the seat cushion. This arrangement makes it possible to appropriately suppress the yaw rotation of the right and left ischium of a seater by the pair of side bulged portions.

3. The main cover and/or the side cover may be made of leather as well as fabric.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved seat, and/or methods of making and using the same.

We claim:

1. A seat, comprising:
a cushion body configured to elastically support a seater; and
a seat frame configured to support the cushion body, wherein the cushion body has a main portion and two side portions that is a side portion of the main portion in a seat width direction, wherein the main portion has a main pad and a main substrate, and wherein the main substrate has a pair of side bulged portions in the seat width direction configured to bulge into a pair of recessed parts in the two side portions on the backside of the main pad.

2. The seat according to claim 1, wherein the pair of side bulged portions are provided at a position where the pair of side bulged portions overlaps the arrangement in the seat height direction with a pelvis support portion of the main portion, or a position where the pair of side bulged portions overlaps the arrangement in the seat front-rear direction with the ischium support portion of the main portion.

3. The seat according to claim 1, wherein the main substrate is fixed to the seat frame.

4. The seat according to claim 1, wherein the pair of the side bulged portions have an inclined surface that is inclined to support the main pad in the corresponding pair of recessed parts from the obliquely outer side of the backside of the seat.

5. A seat, comprising:
a cushion body configured to elastically support a seater; and
a seat frame configured to support the cushion body, wherein the cushion body has a main portion, wherein the main portion has a main pad and a main substrate, wherein the main pad has a recessed portion positioned on a right and left sides portions of the back surface of the pad, and wherein the main substrate has a pair of side bulged portions configured to bulge into a pair of recessed parts.

6. The seat according to claim 5, wherein the recessed portion is a concave portion in accordance with a shape of the side bulged portion.

7. The seat according to claim 5, wherein a bulging shape of the pair of side bulged portions is an extruded shape that forms an inclined surface to face diagonally inward toward a front side of the seat.

8. The seat according to claim 5, further comprising a fabric member supporting the main portion against the seat frame from the backside of the seat.
